(19) United States
(12) Patent Application Publication
(10) Pub. No.: US 2024/0249860 A1
(43) Pub. Date: Jul. 25, 2024

(54) SUPERCONDUCTING CONDUCTOR AND WINDING

(71) Applicant: Kyoto University, Kyoto-shi, Kyoto (JP)

(72) Inventors: Naoyuki AMEMIYA, Kyoto-shi, Kyoto (JP); Xijie LUO, Kyoto-shi, Kyoto (JP)

(21) Appl. No.: 18/561,924

(22) PCT Filed: Mar. 11, 2022
(86) PCT No.: PCT/JP2022/010786

§ 371 Date: Nov. 17, 2023

(30) Foreign Application Priority Data
May 18, 2021 (JP) 2021-083634

(51) Int. Cl. H01B 12/08; H01F 6/06

(52) U.S. Cl. CPC H01B 12/08; H01F 6/06

(57) ABSTRACT

Provided is a superconducting conductor with reduced loss. The superconducting conductor (10) comprises a stranded wire (1) having a plurality of metal element wires twisted together (11); and one or more tape-shaped superconductor wires (2) each having a superconductor layer formed on a surface of a flexible substrate, and being spirally wound around the stranded wire (1) along its longitudinal direction, the metal element wires (11) having a diameter of 0.3 mm or less, and the stranded wire (1) having a diameter of 5 mm or less.

### TECHNICAL FIELD

The present invention relates to a cable-like superconducting conductor and a winding wound with the superconducting conductor.

### BACKGROUND ART

High-temperature superconductivity has been attracting attention as a technique for efficiently generating, transmitting, converting, using, and storing electrical energy. For example, if a wire produced using a high-temperature superconducting material (hereinafter referred to as “high-temperature superconductor wire”) or a superconducting conductor formed by assembling such wires is used in an armature winding of generators or motors, it is possible to flow a large current at a high current density through the armature winding. This can reduce the size of the armature iron core and is expected to reduce the weight of generators and motors. The reduction of the weight of generators and motors can lead to, for example, the electrification of aircrafts and to more introduction of large-scale floating offshore wind turbines. Since the electrification of aircrafts and introduction of wind turbines are expected to reduce CO₂ emissions, the high-temperature superconductivity technique is expected to make significant contributions to the realization of a decarbonized society.

On the other hand, when a superconductor wire is used in AC, AC loss occurs due to AC magnetic field. In general, when current flows in a superconductor wire or a magnetic field is applied to a superconductor wire, magnetic flux penetrates the superconductor wire in the form of a fluxoid. Under operation conditions in which a DC current or a DC magnetic field is applied, fluxoids do not move but remain stationary. On the other hand, under operation conditions in which an AC current or an AC magnetic field is applied, fluxoids must move due to changes in magnetic flux distribution at the position of the superconductor wire. When fluxoids move, a kind of friction is generated and what corresponds to this friction heat is AC loss. In particular, in AC applications for windings (coils), AC loss due to an AC magnetic field applied to a superconductor wire or superconducting conductor used in the winding from the transverse direction (or the direction intersecting the longitudinal direction if the superconductor wire or superconducting conductor extends in the longitudinal direction) increases.

Various methods have been proposed to reduce such AC loss occurring in superconductor wires. For example, Patent Literature (PTL) 1 discloses a superconducting conductor that reduces AC loss and a superconductor cable comprising the superconducting conductor.

### CITATION LIST

### Patent Literature

PTL 1: JP2008-47519A

### SUMMARY OF INVENTION

### Technical Problem

In most cases, a single superconductor wire can carry a current of only tens to hundreds of amperes. In order to socially implement devices using high-temperature superconductivity, multiple superconductor wires are required to be assembled into a superconducting conductor with excellent flexibility that can carry a large current at a high current density and enables windings.

However, most practical high-temperature superconductor wires have a tape shape (hereinafter also referred to as “superconducting tape wires”), and it is not easy to assemble multiple superconducting tape wires to form a superconducting conductor that can carry a large current at a high current density and has excellent flexibility. Simply stacking multiple superconducting tape wires causes unbalanced inductance between the multiple superconducting tape wires. As a result, the current distribution becomes non-uniform during AC current flow, the current that can flow in the superconducting state throughout the superconducting conductor decreases, and AC loss increases, making it impossible to use the superconducting conductor for AC applications.

In addition, some superconducting conductor configurations include metal components, such as core materials, other than superconductor wires. When such a superconducting conductor is used in AC, the AC magnetic field causes eddy current loss in the core material, which is a metal component.

The occurrence of AC loss in superconductor wires, the occurrence of eddy current loss in metal components, and the difficulty in assembling multiple superconducting tape wires to form a superconducting conductor that can carry a large current at a high current density and has excellent flexibility have been a bottleneck for the social implementation of devices using high-temperature superconductivity.

An object of the present invention is to provide a superconducting conductor with reduced loss.

Another object of the present invention is to provide a superconducting conductor in which the reduction of the critical current is reduced or prevented.

### Solution to Problem

To achieve the above objects, the present invention includes, for example, the following embodiments.

### Item 1

A superconducting conductor comprising:
a stranded wire having a plurality of metal element wires twisted together; and
one or more tape-shaped superconductor wires each having a superconductor layer formed on a surface of a flexible substrate, and being spirally wound around the stranded wire along its longitudinal direction,
the metal element wires having a diameter of 0.3 mm or less, and the stranded wire having a diameter of 5 mm or less.

### Item 2

The superconducting conductor according to Item 1, wherein an angle made between the longitudinal direction of each superconductor wire and the longitudinal direction of the stranded wire is 45 degrees or more and less than 90 degrees.

### Item 3

The superconducting conductor according to Item 1 or 2, wherein the metal element wires are twisted in the same direction.

### Item 4

The superconducting conductor according to any one of Items 1 to 3, wherein the metal element wires are twisted with the same twist pitch.

### Item 5

The superconducting conductor according to any one of Items 1 to 4, further comprising a flexible smoothing layer disposed between the stranded wire and the superconductor wires so as to cover the periphery of the stranded wire along its longitudinal direction.

### Item 6

The superconducting conductor according to Item 5, wherein the smoothing layer is made of a resin or a metal, and covers the periphery of the stranded wire cylindrically or spirally.

### Item 7

The superconducting conductor according to any one of Items 1 to 6, comprising a plurality of the superconductor wires, wherein the superconductor wires are spirally wound around the stranded wire along its longitudinal direction.

### Item 8

The superconducting conductor according to Item 7, wherein the superconductor wires are spirally wound around the stranded wire along its longitudinal direction in different directions.

### Item 9

The superconducting conductor according to any one of Items 1 to 8, wherein in the superconductor wires, a plurality of the superconductor layers extend in the longitudinal direction of the substrate and are arranged in parallel to the transverse direction of the substrate.

### Item 10

The superconducting conductor according to any one of Items 1 to 9, further comprising one or more normally conductive materials each electrically connecting one or more of the superconductor wires and at least one of the metal element wires of the stranded wire.

### Item 11

The superconducting conductor according to any one of Items 1 to 10, further comprising a plurality of normally conductive materials each electrically connecting one or more of the superconductor wires and at least one of the metal element wires of the stranded wire,
wherein the normally conductive materials are arranged to minimize the integral value of a magnetic field in a transverse direction with respect to the superconducting conductor in a section of the superconducting conductor between adjacent normally conductive materials.

### Item 12

A superconducting conductor comprising:
a stranded wire having a plurality of metal element wires twisted together;
one or more tape-shaped superconductor wires each having a superconductor layer formed on a surface of a flexible substrate, and being spirally wound around the stranded wire along its longitudinal direction; and
a flexible smoothing layer disposed between the stranded wire and the superconductor wires so as to cover the periphery of the stranded wire along its longitudinal direction.

### Item 13

A superconducting conductor comprising:
a stranded wire having a plurality of metal element wires twisted together; and
one or more tape-shaped superconductor wires each having a superconductor layer formed on a surface of a flexible substrate, and being spirally wound around the stranded wire along its longitudinal direction,
the superconductor wires having a bending angle of 12 degrees or less along the outer circumference of the stranded wire.

### Item 14

A winding wound with the superconducting conductor according to any one of Items 1 to 13.

### Advantageous Effects of Invention

According to the present invention, there can be provided a superconducting conductor with reduced loss.

### BRIEF DESCRIPTION OF DRAWINGS

FIG. 1 shows schematic diagrams for explaining the principle of loss reduction in the cable-like superconducting conductor according to the present invention.

FIG. 2 shows diagrams schematically illustrating the configuration of a superconducting conductor 10A according to a first embodiment of the present invention.

FIG. 3 is a diagram schematically illustrating the configuration of a superconducting tape wire 2 of one of the various forms provided in the superconducting conductor 10A according to the first embodiment of the present invention, and is a perspective view schematically illustrating the configuration of a superconductor wire 2A of a first form.

FIG. 4 is a diagram schematically illustrating the configuration of a superconducting tape wire 2 of one of the various forms provided in the superconducting conductor 10A according to the first embodiment of the present invention, and is a perspective view schematically illustrating the configuration of a superconductor wire 2B of a second form.

FIG. 5 is a diagram schematically illustrating the configuration of a superconducting tape wire 2 of one of the various forms provided in the superconducting conductor 10A according to the first embodiment of the present invention, and is a perspective view schematically illustrating the configuration of a superconductor wire 2C of a third form.

FIG. 6 shows diagrams schematically illustrating the configuration of a superconducting conductor 10B according to a second embodiment of the present invention.

FIG. 7 shows perspective views schematically illustrating the configurations of superconducting tape wires 2 (2D, 2E, and 2F) of various forms.

FIG. 8 is a graph showing the verification results of the loss reduction effect in Example 1.

FIG. 9 shows diagrams schematically illustrating the configuration of a superconducting conductor 10C (10) produced in Example 2.

FIG. 10 shows the measurement results of the electric field-current characteristics of the superconducting conductor 10C (10) produced in Example 2.

FIG. 11 shows diagrams schematically illustrating the configuration of a superconducting conductor 10D (10) produced in Example 3.

FIG. 12 shows the measurement results of the electric field-current characteristics of the superconducting conductor 10D (10) produced in Example 3.

FIG. 13 shows diagrams schematically illustrating the configuration of a superconducting conductor 10E (10) produced in Example 4.

FIG. 14 shows the measurement results of the electric field-current characteristics of the superconducting conductor 10E (10) produced in Example 4.

FIG. 15 shows diagrams schematically illustrating the configuration of a superconducting conductor 10F (10) produced in Example 5.

FIG. 16 shows the measurement results of the electric field-current characteristics of the superconducting conductor 10F (10) produced in Example 5.

FIG. 17 shows diagrams schematically illustrating the configuration of a superconducting conductor 10G (10) produced in Example 6.

FIG. 18 shows the measurement results of the electric field-current characteristics of the superconducting conductor 10G (10) produced in Example 6.

FIG. 19 shows diagrams schematically illustrating the configuration of a superconducting conductor 90 produced as Comparative Example 3.

FIG. 20 shows the measurement results of the electric field-current characteristics of the superconducting conductor 90 produced in Comparative Example 3.

### DESCRIPTION OF EMBODIMENTS

Embodiments of the present invention are described in detail below with references to the accompanying drawings. In the following description and drawings, identical reference symbols denote identical or similar elements, and redundant descriptions of the same or similar elements are thus omitted.

### Meaning of Terms

The meanings of terms used in the following description are explained. Some of the terms already used herein have been explained in their first appearance, but explanations are also repeated for the sake of clarity.

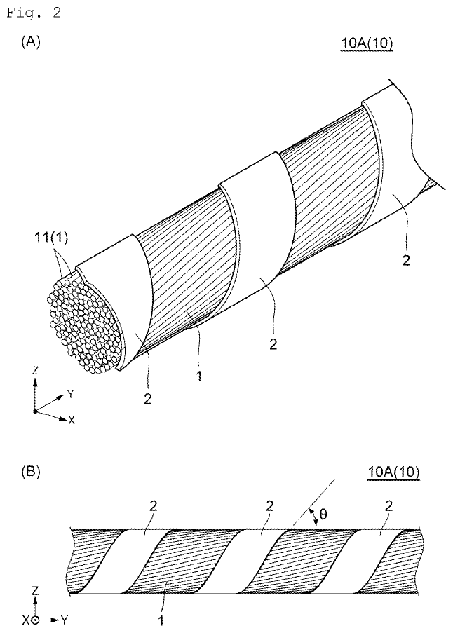

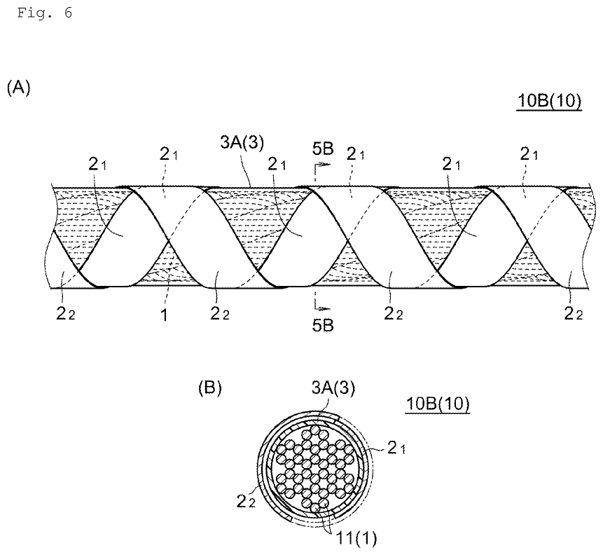

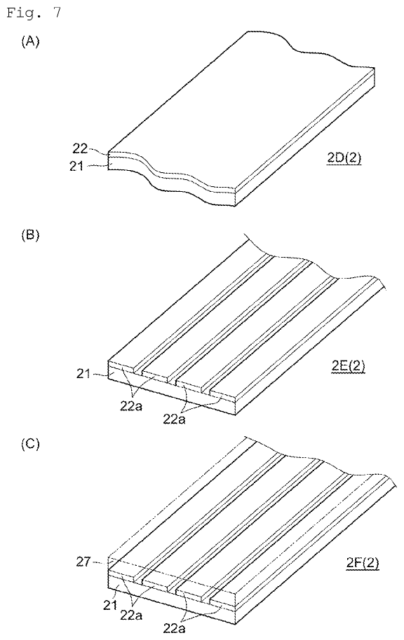

Superconductor wires refer to wires produced using superconducting materials, and superconducting tape wires refer to tape-shaped flat superconductor wires. FIGS. 3 to 5 show exemplary superconducting tape wires. Superconducting conductors refer to conductors produced by assembling superconductor wires. FIGS. 2 and 6 show exemplary superconducting conductors assembled in cables.

AC loss is the loss generated by the AC magnetic field when the superconductor wire is used in AC. In general, when current flows in a superconductor wire or a magnetic field is applied to a superconductor wire, magnetic flux penetrates the superconductor wire in the form of a fluxoid. Under operation conditions in which a DC current or a DC magnetic field is applied, fluxoids do not move but remain stationary. On the other hand, under operation conditions in which an AC current or an AC magnetic field is applied, fluxoids must move due to changes in magnetic flux distribution at the position of the superconductor wire. When fluxoids move, a kind of friction is generated and what corresponds to this friction heat is AC loss.

The electromotive force is a force that acts in the form of a loop to cause eddy currents to flow in the superconductor wire by electromagnetic induction when the magnetic field applied perpendicularly to the superconductor layer of the superconductor wire (strictly, the component of the magnetic field applied that is perpendicular to the superconductor layer) changes with time. The length of the longest part of the loop of the electromotive force along the longitudinal direction of the superconductor wire (referred to below as the “electromotive force loop length” for the sake of simplification) is equal to the length of the portion of the superconductor wire in the longitudinal direction, where the magnetic field is in the same direction; more precisely, the time differential of the magnetic field is in the same direction. Even if an electromotive force is generated, eddy currents cannot flow in the absence of a normal conductor or a superconductor.

The eddy currents mean currents induced in the form of a loop (vortex) in a conductor or superconductor by an electromotive force caused by electromagnetic induction. The eddy currents are a concept that includes both persistent eddy currents 98 and coupling currents 99.

The length of the eddy currents is the length of the longest portion of the eddy currents distributed in the superconductor wire and flowing along the longitudinal direction of the superconductor wire. The eddy currents can only flow within the electromotive force loop length. That is, the eddy current length does not exceed the electromotive force loop length.

The coupling currents are a type of eddy currents, and the coupling time constant is the decay time constant of coupling current. The coupling currents decay depending on a coupling time constant τ_{c}, which is a ratio of the self-inductance L_{cc} and resistance R_{cc} determined by its route. The self-inductance L_{cc} is proportional to the length of the eddy currents (coupling currents), whereas the resistance R_{cc} is inversely proportional to the length of the eddy currents (coupling currents). Accordingly, the coupling time constant τ_{c} is proportional to the square of the length of the eddy currents (coupling currents).

### Principle of Loss Reduction

It is assumed that a tape-shaped superconductor wire (superconducting tape wire) is spirally wound around a core material along its longitudinal direction to produce a cable-like superconducting conductor. Losses in such a cable-like superconducting conductor include eddy current loss in the core material and AC loss in the superconducting tape wire.

In the cable-like superconducting conductor according to the present invention, the eddy current loss in the core material and the AC loss in the superconducting tape wire can be reduced by comprising the configurations described below alone or in combination.

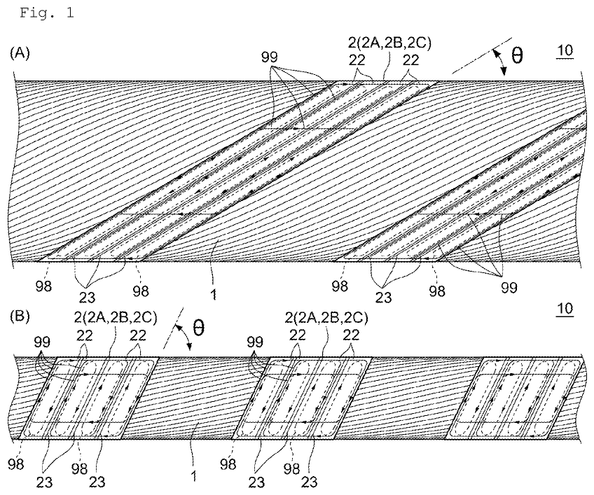

FIG. 1 shows schematic diagrams for explaining the principle of loss reduction in the cable-like superconducting conductor according to the present invention.

In the cable-like superconducting conductor 10 according to the present invention, a tape-shaped superconductor wire 2 is spirally wound around a stranded wire 1, which functions as a core material. In FIG. 1, (A) shows an example in which the stranded wire 1 has a thick diameter and the tape-shaped superconductor wire 2 has a small winding angle θ, and (B) shows an example in which the stranded wire 1 has a thin diameter and the tape-shaped superconductor wire 2 has a large winding angle θ. In order to facilitate understanding, in the shown superconductor wire 2 (2A, 2B, 2C), a superconductor layer 22 is wound around the stranded wire 1 while facing the outside; however, the loss is similarly reduced even if the superconductor layer 22 is wound around the stranded wire 1 while facing the inside.

### Reduction of Eddy Current Loss in Core Material

It is desirable to form the core material using a metal with high electrical conductivity (low electrical resistivity), such as copper, so as to provide a detour path (shunt path) for the current when the superconducting state is destroyed in the superconducting tape wire 2, or when an overcurrent exceeding the current that can flow in the superconducting state flows through the superconducting tape wire 2 due to some external accident, for example.

A solid circular cross-section single wire, a stranded wire obtained by twisting element wires with a relatively thick diameter, or a stranded wire obtained by twisting a plurality of element wires that are not isolated from each other is used as a core material, and the superconducting tape wire 2 is spirally wound around such a core material along its longitudinal direction to produce a cable-like superconducting conductor 10. When the thus-produced cable-like superconducting conductor 10 is exposed to a transverse AC magnetic field, large eddy current loss occurs. For example, in a solid copper core material with a diameter of 3 mm, the measured value of eddy current loss is about 1.42 W/m in an AC magnetic field with a peak value of 100 mT and a frequency of 65.44 Hz.

In the cable-like superconducting conductor 10 according to the present invention shown in FIG. 1, a stranded wire 1 obtained by twisting element wires with a relatively thin diameter is used as the core material. This reduces eddy current loss in the core material. For example, in a stranded wire (litz wire) with a diameter of about 3.1 mm produced by twisting 50 insulated element wires 11 with a diameter of 0.3 mm, the measured value of eddy current loss is about 6.87 mW/m in an AC magnetic field with a peak value of 100 mT and a frequency of 65.44 Hz.

In the present invention, the diameter of the element wires 11 of the stranded wire 1 obtained by twisting element wires with a relatively thin diameter can be, for example, about 0.3 mm or less, in view of the element wire diameter (about 0.3 mm to about 0.1 mm) of the stranded wire in the Examples, described below. Similarly, the diameter of the stranded wire 1 can be, for example, about 5 mm or less, in view of the diameter (about 2.8 mm to about 3.5 mm) of the core material in the Examples, described below.

### Reduction of AC Loss in Superconducting Tape Wire

When the superconducting tape wire 2 is exposed to an AC magnetic field in the transverse direction (when the superconducting tape wire extends in the longitudinal direction, a direction intersecting the longitudinal direction) and in the direction perpendicular to the wide surface of the tape, large AC loss (e.g., a measured value of 3.82 W/m in an AC magnetic field with a peak value of 100 mT and a frequency of 65.44 Hz) occurs due to its wide shape. In a superconducting conductor formed by assembling many superconducting tape wires 2, the AC loss increases in proportion to the number of wires.

As shown in FIG. 1, when the tape-shaped superconductor wire 2 (superconducting tape wire) is spirally wound around the core material along its longitudinal direction, the AC loss is reduced because the portion of the unit length (1 m) of the superconducting tape wire 2 that is exposed to an AC magnetic field in the transverse direction and in the direction perpendicular to the tape surface is shortened.

More desirably, when the superconducting tape wire 2 spirally wound around the core material along its longitudinal direction is multifilamentized, the AC loss in the superconducting tape wire relative to the AC magnetic field in transverse direction is further reduced. The superconductor wire 2 shown in FIG. 1 corresponds to each of the multifilament superconductor wires 2 (2A, 2B, and 2C) shown in FIGS. 3 to 5 in which a superconductor layer 22 is multifilamentized. An insulating section 23 is disposed between a plurality of superconductor layers 22 and 22, and electrically isolates the plurality of superconductor layers 22 and 22. Depending on the form of the superconductor wire 2, a connecting section 24 and a conducting layer 25 (25a, 25b) are disposed in the superconductor wire 2; however, these configurations are not shown in FIG. 1.

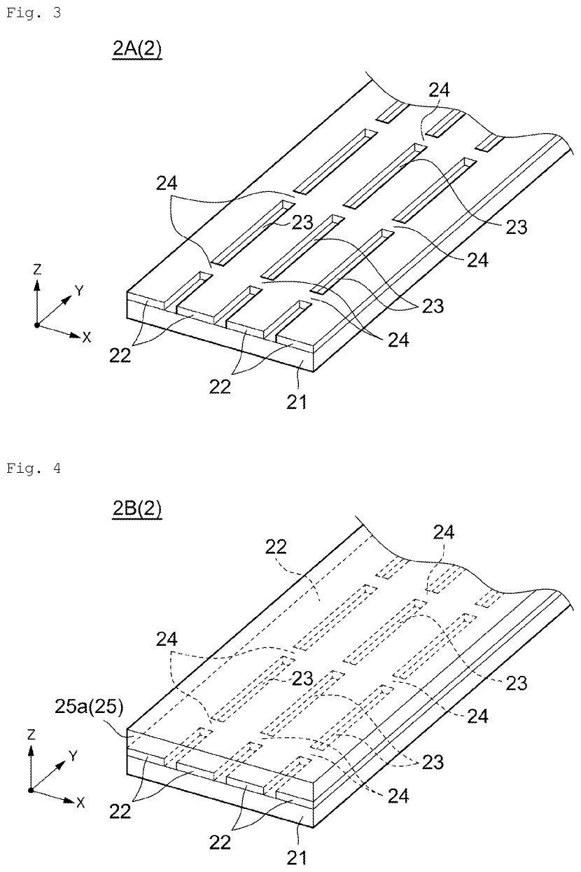

In particular, when the superconductor wire 2B comprising a conducting layer 25a shown in FIG. 4 is used as the superconducting tape wire 2 spirally wound around the core material along its longitudinal direction, robustness is improved as compared to the superconductor wire 2A shown in FIG. 3. As described later with reference to FIG. 4, the conducting layer 25a functions as a shunt layer to divert the current flowing through the superconductor layers 22 in the event of an anomaly in the superconductor layers 22.

In order to more effectively reduce AC loss with respect to the AC magnetic field in the transverse direction by using the superconductor wire 2B comprising the conducting layer 25a, which reduces AC loss and improves robustness, it is desirable to quickly decay the coupling current 99 flowing through the superconductor wire 2B via the conducting layer 25a. In order to quickly decay the coupling current 99, it is desirable to shorten the coupling time constant. Since the coupling time constant is proportional to the square of the length of the coupling current 99, it is desirable to shorten the length of the coupling current 99 in order to shorten the coupling time constant.

In the cable-like superconducting conductor to be produced, when the core material has a relatively large diameter and the superconducting tape wire 2 (2B) has a relatively small winding angle θ, as shown in FIG. 1(A), the length of the coupling current 99 becomes longer, the coupling time constant becomes larger, and the AC loss with respect to the AC magnetic field in the transverse direction cannot be effectively reduced. In addition, such a cable-like superconducting conductor has low current density and insufficient flexibility for producing windings.

In contrast, in the cable-like superconducting conductor 10 according to the present invention, desirably, the superconducting tape wire 2 (2B) is spirally wound around a core material with a relatively small diameter at a relatively large winding angle θ so that the length of the coupling current 99 is shortened, as shown in FIG. 1(B). This shortens the coupling time constant, can quickly decay the coupling current 99, and further reduces AC loss in the superconducting tape wire 2 (2B) spirally wound around the core material. This also makes it possible to obtain high current density and flexibility necessary for the application of winding the cable-like superconducting conductor to produce a winding.

The coupling time constant τ_{c} is proportional to the square of the length of the eddy current (coupling current). Therefore, when the superconducting tape wire 2 (2B) is wound around the core material so as to shorten the length of the coupling current 99, which flows in the form of a loop inside the superconducting tape wire 2 (2B), the coupling time constant is shortened, the coupling current can be quickly decayed, and the AC loss in the superconducting tape wire 2 (2B) is further reduced. In the cable-like superconducting conductor 10 according to the present invention, the way of winding the superconducting tape wire 2 (2B) around core material so that the length of the coupling current 99 is shortened includes spirally winding the superconducting tape wire 2 (2B) around a core material with a relatively small diameter, and increasing the winding angle θ of the superconducting tape wire 2 (2B) when spirally winding the superconducting tape wire 2 (2B) around the core material. This can shorten the length of the coupling current 99 flowing in the form of a loop inside the superconducting tape wire 2 (2B).

In the present invention, the relatively small diameter of the core material can be, for example, about 5 mm or less, in view of the diameter (about 2.8 mm to about 3.5 mm) of the core material in the Examples, described below. Similarly, the relatively large winding angle θ can be, for example, about 45 degrees or more, in view of the winding angle (about 55 degrees) of the superconducting tape wire 2 in the Examples, described below.

Assuming that the superconducting tape wire 2 is spirally wound around the core material, winding is easiest when the winding angle θ is 0 degrees or 90 degrees. If the winding angle θ is exactly 45 degrees, the superconducting tape wire 2 is twisted and is difficult to wind. The winding angle θ of 45 degrees is the value of the boundary winding angle. The smaller the value and the closer to 0 degrees as possible, or the larger the value and the closer to 90 degrees as possible, the easier it is to wind. As shown in FIG. 1(B), in order to shorten the length of the coupling current 99, the superconducting tape wire 2 is spirally wound around the core material at a relatively large winding angle θ. That is, as exemplified by 55 degrees in the Examples described later, the superconducting tape wire 2 should be spirally wound around the core material at an angle larger than 45 degrees, which is the value of the boundary winding angle θ.

### Prevention of Reduction of Critical Current

If the superconducting tape wire 2 is spirally wound around a core material with a relatively small diameter (e.g., about 5 mm or less) at a relatively large winding angle θ (e.g., about 45 degrees or more), the superconducting tape wire 2 tends to bend at the portion of the stranded wire 1 that touches the element wire, and the critical current of the superconducting tape wire 2 may decrease.

In the cable-like superconducting conductor 10 according to the present invention, unevenness (steps) is reduced in the outer circumference of the stranded wire 1 by adopting the following configurations i) to iv) alone or in combination, in addition to having the configuration described above. This further prevents the reduction of the critical current in the superconducting tape wire 2, in addition to the reduction of the losses described above.
i) The diameter of the element wires constituting the stranded wire 1 is reduced. The diameter is about 0.3 mm or less, and preferably about 0.2 mm or less.
ii) The element wires are twisted in the same directions.
iii) The element wires are twisted with the same twist pitch.
iv) The periphery (outer circumference) of the stranded wire 1 is covered with a flexible layer to smooth it. The layer is made of a resin or a metal.

### First Embodiment

### Superconducting Conductor

FIG. 2 shows diagrams schematically illustrating the configuration of a superconducting conductor 10A according to a first embodiment of the present invention. FIG. 1(A) is a perspective view of the superconducting conductor 10A, and FIG. 1(B) is a side view of the superconducting conductor 10A. In the illustrated form, the Y-axis direction is the longitudinal direction of the stranded wire 1, and the X-axis and Z-axis directions are the radial directions (transverse directions) of the stranded wire 1.

The superconducting conductor 10A (10) according to the first embodiment comprises a stranded wire 1 having a plurality of element wires 11 twisted together, and a tape-shaped superconductor wire 2 having a superconductor layer formed on a surface of a flexible substrate, and spirally wound around the stranded wire 1 along its longitudinal direction.

The stranded wire 1 is formed by twisting together a plurality of element wires 11. For example, the diameter of the element wires 11 is about 0.3 mm or less, and the diameter of the stranded wire 1 is about 5 mm or less. Preferably, the diameter of the element wires 11 is about 0.2 mm or less. In the illustrated form, the diameter of the element wires 11 is about 0.1 mm. The element wire 11 is formed using, for example, a metal with high electrical conductivity (low electrical resistivity), such as copper. Preferably, for example, an insulating material, such as enamel, is used to form an insulation layer (not shown) on the surface of the element wires 11, and the element wires 11 are each insulated.

The superconducting tape wire 2 is a tape-shaped superconductor wire, and is spirally wound around the stranded wire 1 along its longitudinal direction. The superconducting tape wire 2 has a flexible substrate 21 and a superconductor layer 22 formed on the surface of the substrate 21. In the illustrated embodiment, the superconducting tape wire 2 is wound around the stranded wire 1 with the superconductor layer 22 facing the inside. In this embodiment, the superconductor layer 22 is produced using a high-temperature superconducting material. The superconducting tape wire 2 is described later with reference to FIGS. 3 to 5.

In the superconducting conductor 10A (10) according to the first embodiment, a stranded wire 1 having a plurality of element wires 11 twisted together is used as a core material. The diameter of the element wires 11 is about 0.3 mm or less, and the diameter of the stranded wire 1 is about 5 mm or less. This reduces eddy current loss in the stranded wire 1, which is the core material.

In order to reduce AC loss in the superconducting tape wire 2, the winding angle of the superconducting tape wire 2, i.e., the angle θ made between the longitudinal direction of the superconductor wire 2 and the longitudinal direction of the stranded wire 1, is preferably about 45 degrees or more and less than about 90 degrees. In addition, when the superconducting tape wire 2 is multifilamentized as shown in FIGS. 3 to 5, AC loss in the superconducting tape wire 2 is further reduced.

In order to prevent the reduction of the critical current in the superconducting tape wire 2, the element wires 11 constituting the stranded wire 1 have a small diameter. For example, the diameter of the element wires 11 is about 0.3 mm or less, and preferably about 0.2 mm or less. Further, it is preferable that the element wires 11 are twisted in the same direction, and it is also preferable that the element wires 11 are twisted with the same twist pitch.

### Superconducting Tape Wire

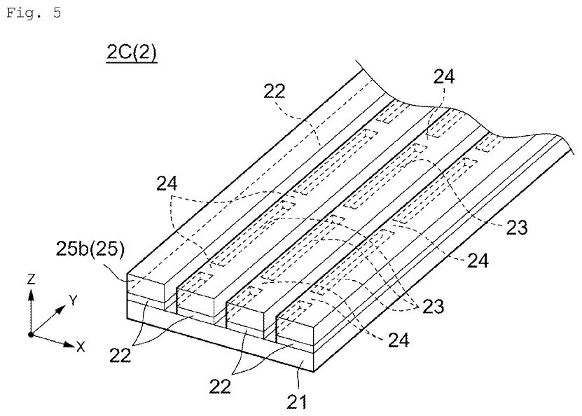

FIGS. 3 to 5 are diagrams showing the configurations of superconducting tape wires 2 of the various forms provided in the superconducting conductor 10A according to the first embodiment of the present invention. FIG. 3 is a perspective view schematically illustrating the configuration of the superconductor wire 2A of the first form. FIG. 4 is a perspective view schematically illustrating the configuration of the superconductor wire 2B of the second form. FIG. 5 is a perspective view schematically illustrating the configuration of the superconductor wire 2C of the third form. In the illustrated forms, the Y-axis direction is the longitudinal direction of the superconductor wire 2, the X-axis direction is the transverse direction of the superconductor wire 2, and the Z-axis direction is the thickness direction of the superconductor wire 2.

In any of the superconductor wires 2A, 2B, and 2C of the forms shown in FIGS. 3 to 5, a plurality of superconductor layers 22 are disposed in parallel to the transverse direction of the substrate 21. The superconductor wires 2A, 2B, and 2C of the forms shown in FIGS. 3 to 5 are referred to as multifilament superconductor wires.

The superconductor wire 2A (2) of the first form shown in FIG. 3 comprises a substrate 21, a plurality of superconductor layers 22, insulating sections 23, and a plurality of connecting sections 24.

The substrate 21 is formed in a tape shape using, for example, a nickel-based alloy or stainless steel. For example, the material of the substrate 21 can be Hastelloy (registered trademark). The substrate 21 is flexible, and the superconductor wire 2A (2) is spirally wound and used, as shown in FIG. 2.

An intermediate layer (not shown) that serves as a base for the superconductor layers 22 is formed on the surface of the substrate 21 as required. The material for the intermediate layer can be, for example, a material whose physical characteristic value, such as coefficient of thermal expansion or lattice constant, exhibits an intermediate value between the value of the substrate 21 and the value of the superconductor, which is a component for forming the superconductor layers 22. For example, the material of the intermediate layer can be LaMnO₃. In this form, an intermediate layer is formed on the surface of the substrate 21. In the description of the present specification, the substrate 21 having an intermediate layer formed thereon is inclusively referred to as the substrate 21.

The superconductor layers 22 pass currents in the superconductor wire 2A in a superconducting manner. In this form, in order to reduce AC loss, superconductor layers 22 are multifilamentized and formed on the surface of substrate 21. The superconductor layers 22 extend in the longitudinal direction of the substrate 21, and a plurality of superconductor layers 22 are disposed in parallel in the transverse direction of the substrate 21. For example, the superconductor layers 22 are formed using a REBCO high-temperature superconductor, which is a kind of ceramics. REBCO is a copper oxide superconductor having a composition formula represented by the chemical formula REBa₂Cu₃O_{7-δ} (wherein RE represents a rare earth element, such as Y, Gd, Eu, or Sm). In the description below, the multifilamentary superconductor layers 22 are called superconductor filaments 22, or briefly referred to as filaments 22 or simply called superconductor layers 22.

The insulating sections 23 extend in the longitudinal direction of the substrate 21, are disposed between a plurality of superconductor layers 22, 22, and electrically insulate the plurality of superconductor layers 22, 22. For example, in this form, the insulating sections 23 are formed as grooves that expose the surface of the substrate 21 by three-dimensionally patterning the superconductor layers 22 by, for example, a known photolithography process. In this form, the superconductor wire 2A has a plurality of insulating sections 23, and the insulating sections 23 are individually disposed between a plurality of superconductor layers 22, 22 disposed in parallel.

The connecting sections 24 are disposed in the insulating sections 23 along the longitudinal direction of the substrate 21 and electrically connect a plurality of adjacent superconductor layers 22, 22 in a superconducting manner. In the superconductor wire 2A, a plurality of connecting sections 24 are provided in the insulating sections 23 along the longitudinal direction of the substrate 21. In this form, the connecting sections 24 are formed integrally with the superconductor layers 22 using the same superconducting material as the superconductor layers 22.

Since the connecting sections 24 electrically connect a plurality of adjacent superconductor layers 22, 22 in a superconducting manner, the superconducting shunt of the currents flowing through the superconductor layers 22 is improved, and the robustness of the superconductor wire 2A is improved. That is, even if the transition to a normal conducting state locally occurs in a superconductor layer 22 for some reason, the connecting sections 24 bridge the adjacent superconductor layers 22, 22 in a superconducting manner, and current is shunted from the superconductor layer 22 that has transited to a normal conducting state to an adjacent superconductor layer 22, whereby the quench of the entire superconductor wire 2A is prevented.

For example, the length (width) along the transverse direction of the superconductor wire 2A is about 2 mm to about 4 mm, and preferably about 1 mm to about 4 mm. The length (width) along the transverse direction of one multifilamentary superconductor layer 22 is preferably from about 0.4 mm to about 1 mm, and more preferably from about 0.1 mm to about 1 mm. For example, the thickness of the entire superconductor wire 2A including the substrate 21 and the superconductor layers 22 is in the range of about 150 μm to about 50 μm, and preferably in the range of about 50 μm to about 30 μm. Since the superconductor wire 2A is spirally wound and used, the total thickness of superconductor wire 2A including the substrate 21 and the superconductor layers 22 is more preferably less than about 30 μm.

The superconductor wire 2B (2) of the second form shown in FIG. 4 is different from the superconductor wire 2A of the first form shown in FIG. 3 in that the superconductor wire further comprises a conducting layer 25a (25) covering the superconductor layer 22, the insulating sections 23, and the connecting sections 24. The configuration of the superconductor wire 2B of the second form, which is described below, is the same as that of the superconductor wire 2A of the first form, unless otherwise specified. Accordingly, duplicate descriptions are omitted.

In the second form, the superconductor wire 2B (2) further comprises a conducting layer 25a (25) covering the superconductor layers 22, the insulating sections 23, and the connecting sections 24. In the illustrated form, the conducting layer 25a is formed so as to cover the superconductor layers 22, the insulating sections 23, and the connecting sections 24, rather than the superconductor layers 22 alone. The conducting layer 25a functions as a shunt layer to divert the current flowing through the superconductor layers 22 in the event of an anomaly in the superconductor layers 22. For example, the conducting layer 25a is formed of copper. In the illustrated form, the insulating sections 23 are formed as grooves whose bottom reaches the surface of the substrate 21. The grooves are filled with copper, which functions as the conducting layer 25a.

The superconductor wire 2B of the second form, which comprises a conducting layer 25a, has improved robustness as compared to the superconductor wire 2A of the first form.

The superconductor wire 2B of the second form can achieve the same AC loss reduction effect as that of the superconductor wire 2A of the first form in a limited, but practically sufficient, operating frequency range.

As in the first form, the superconductor wire 2B of the second form is spirally wound along the axis of the stranded wire 1, which is a core material, thus forming the superconducting conductor 10.

The superconductor wire 2C (2) of the third form shown in FIG. 5 is different from the superconductor wire 2A of the first form shown in FIG. 3 in that the superconductor wire further comprises a conducting layer 25b (25) covering the superconductor layers 22. The configuration of the superconductor wire 2C of the third form, which is described below, is the same as that of the superconductor wire 2A of the first form, unless otherwise specified. Accordingly, duplicate descriptions are omitted.

In the third form, the superconductor wire 2C (2) further comprises a conducting layer 25b (25) covering the superconductor layers 22. In the illustrated form, the conducting layer 25b is formed so as to cover only the superconductor layers 22 without covering the insulating sections 23 or the connecting sections 24. The conducting layer 25b functions as a shunt layer to divert the current flowing through a superconductor layer 22 in the event of an anomaly in the superconductor layer 22. For example, the conducting layer 25b is formed of copper. In the illustrated form, the insulating sections 23 are formed as grooves that expose the surface of the substrate 21. The conducting layer 25b is formed so as to cover only the superconductor layers 22, and the grooves are not filled with copper that functions as the conducting layer 25b.

The superconductor wire 2C of the third form can achieve the same AC loss reduction effect as that of the superconductor wire 2A of the first form.

The superconductor wire 2C of the third form, which comprises a conducting layer 25b, has improved robustness as compared to the superconductor wire 2A of the first form. More specifically, by shunting the current from the superconductor layers 22 to the conducting layer 25b provided on the superconductor layers 22, an increase of hot spot temperature can be suppressed.

As in the first form, the superconductor wire 2C of the third form is spirally wound along the axis of the stranded wire 1, which is a core material, thus forming the superconducting conductor 10.

As described above, the superconducting conductor 10A (10) according to the first embodiment can provide a superconducting conductor with reduced loss.

In the superconducting conductor 10A (10) according to the first embodiment, a stranded wire 1 having a plurality of element wires 11 twisted together is used as a core material, the diameter of the element wires 11 is about 0.3 mm or less, and the diameter of the stranded wire 1 is about 5 mm or less. This can reduce eddy current loss in the stranded wire 1, which is the core material. By reducing the diameter of the element wires 11, which form the stranded wire 1, to about 0.3 mm or less, the reduction of the critical current in the superconducting tape wire 2 can be prevented.

The diameter of the element wires 11 being about 0.3 mm or less takes into consideration the element wire diameter (about 0.3 mm to about 0.1 mm) of the stranded wire in the Examples, described below. Similarly, the diameter of the stranded wire 1 being about 5 mm or less takes into consideration the diameter (about 2.8 mm to about 3.5 mm) of the core material in the Examples, described below.

In the superconducting conductor 10A according to the first embodiment, the angle θ made between the longitudinal direction of the superconductor wire 2 and the longitudinal direction of the stranded wire 1 is preferably about 45 degrees or more and less than 90 degrees. This can reduce AC loss in the superconducting tape wire 2.

The angle θ made between the longitudinal direction of the superconductor wire 2 and the longitudinal direction of the stranded wire 1, i.e., winding angle θ, being about 45 degrees or more and less than 90 degrees takes into consideration the winding angle (about 55 degrees) of the superconducting tape wire 2 in the Examples, described below.

Further, in the superconducting conductor 10A according to the first embodiment, a plurality of element wires 11 are preferably twisted in the same direction. This can smooth the outer circumference of the stranded wire 1 and prevent the reduction of the critical current in the superconducting tape wire 2.

Further, in the superconducting conductor 10A according to the first embodiment, a plurality of element wires 11 are preferably twisted with the same twist pitch. This can smooth the outer circumference of the stranded wire 1 and prevent the reduction of the critical current in the superconducting tape wire 2.

### Second Embodiment

The configuration of a superconducting conductor 10B (10) according to the second embodiment is the same as that of the superconducting conductor 10A (10) according to the first embodiment, unless otherwise specified. Accordingly, duplicate descriptions are omitted.

FIG. 6 shows diagrams schematically illustrating the configuration of the superconducting conductor 10B according to the second embodiment of the present invention. FIG. 6(A) is a side view of the superconducting conductor 10B, and FIG. 6(B) is a cross-sectional view of the superconducting conductor taken along line 5B-5B shown in FIG. 6(A).

The superconducting conductor 10B (10) according to the second embodiment is mainly different from the superconducting conductor 10A according to the first embodiment in that the superconducting conductor further comprises a flexible smoothing layer 3A (3) disposed between the stranded wire 1 and the tape-shaped superconductor wire 2 so as to cover the periphery of the stranded wire 1 along its longitudinal direction. The smoothing layer 3A (3) is made of a resin or a metal, and covers the periphery of the stranded wire 1 cylindrically or spirally.

In the illustrated form, the diameter of the element wires 11 is about 0.3 mm, six element wires 11 are Z-twisted together to form one primary stranded wire, and seven primary stranded wires are S-twisted together to form one stranded wire 1.

Further, in the illustrated form, a plurality of tape-shaped superconductor wires 21 and 22 are partially superimposed and spirally wound around the stranded wire 1 along its longitudinal direction. The superconductor wire 21 is wound in an S-shape around the stranded wire 1, and the superconductor wire 22 is wound in a Z-shape around the stranded wire 1. That is, in the illustrated form, a plurality of superconductor wires 21 and 22 are spirally wound around the stranded wire 1 along its longitudinal direction in different directions.

As described above, the superconducting conductor 10B (10) according to the second embodiment can provide a superconducting conductor with reduced loss.

The superconducting conductor 10B (10) according to the second embodiment further comprises a flexible smoothing layer 3A (3) between the stranded wire 1 and the tape-shaped superconductor wires 2. This can smooth the outer circumference of the stranded wire 1 and prevent the reduction of the critical current in the superconducting tape wires 2.

Further, according the superconducting conductor 10B (10) according to the second embodiment, a plurality of superconductor wires 21 and 22 are spirally wound around the stranded wire 1. This can increase the amount of current flowing through the single superconducting conductor 10B.

### OTHER EMBODIMENTS

The present invention is described above by specific embodiments. However, the present invention is not limited to the embodiments described above.

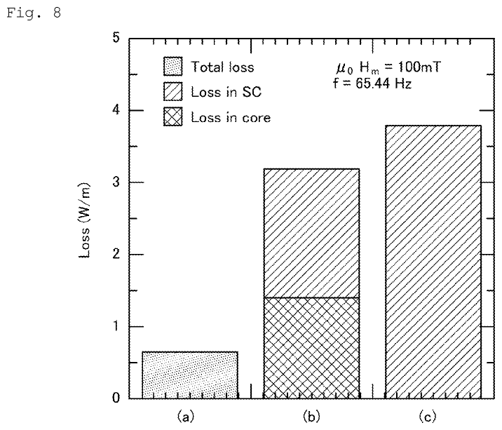

In the embodiments described above, in the superconducting conductor 10, the superconducting tape wires 2 (2A, 2B, and 2C) of the various forms shown in FIGS. 3 to 5 are spirally wound around the stranded wire 1 along its longitudinal direction; however, the superconducting tape wire wound around the stranded wire 1 is not limited to these forms. In the superconducting conductor 10, for example, superconducting tape wires 2 (2D, 2E, and 2F) of the various forms shown in FIGS. 7(A) to (C) may be spirally wound around the stranded wire 1 along its longitudinal direction.

In the superconductor wire 2D (2) of the form shown in FIG. 7(A), a superconductor layer 22 is uniformly formed on the surface of a substrate 21. The superconductor wire 2D of the form shown in FIG. 7(A) is called a monofilament superconductor wire. In the superconductor wire 2E (2) of the form shown in FIG. 7(B), a superconductor layer 22a is divided into filaments with a narrow width and multifilamentized. In the superconductor wire 2F (2) of the form shown in FIG. 7(C), for example, a copper shunt layer 27 is further formed as a conductor shunt layer on the surface of the multifilamentary superconductor layer 22a. The superconductor wires 2E and 2F of the forms shown in FIGS. 7(B) and (C) are also multifilament superconductor wires.

In another embodiment, the cable-like superconducting conductor 10 can further comprise one or more normally conductive materials each electrically connecting one or more of the tape-shaped superconductor wires 2 and at least one element wire 11 of the stranded wire 1. This allows current shunt to the stranded wire 1, which is a conductive core material, and can improve the robustness of the superconducting conductor 10. The position of the normally conductive material may be the end of the superconducting conductor 10 in the longitudinal direction, or may be in the middle of the superconducting conductor 10 in the longitudinal direction.

In still another embodiment, such normally conductive materials are arranged to minimize the integral value of a magnetic field in the transverse direction with respect to the superconducting conductor, preferably zero, in a section of the superconducting conductor between adjacent normally conductive materials. As a result, the presence of the normally conductive materials can suppress eddy current loss due to the eddy current flowing across the element wires 11 of the stranded wire 1, and coupling loss due to the coupling current flowing across the element wires 11 of the stranded wire 1 and the superconductor wire 2.

In the embodiments described above, the superconducting tape wire 2 is wound around the stranded wire 1 with the superconductor layer 22 facing inside; however, the superconducting tape wire 2 may be wound around the stranded wire 1 with the superconductor layer 22 facing outside.

The superconducting conductor 10 produced in each of the embodiments described above may be used as a primary conductor, and a plurality of such primary conductors may be twisted to produce a secondary conductor. This can increase the current capacity of the produced superconducting conductor. A plurality of such secondary conductors may be further twisted to produce a tertiary conductor.

In the second embodiment described above, a plurality of tape-shaped superconductor wires 21 and 22 are spirally wound around the stranded wire 1 along its longitudinal direction in different directions. In this case, the plurality of superconductor wires 21 and 2 are partially superimposed and wound around the stranded wire 1; however, when the superconductor wires 21 and 22 are spirally wound around the stranded wire 1 along its longitudinal direction in the same direction, the superconductor wires 21 and 2 can be wound around the stranded wire 1 without being superimposed.

In the second embodiment described above, the superconducting conductor 10B (10) comprises a flexible smoothing layer 3A (3) between the stranded wire 1 and the tape-shaped superconductor wires 2. In the second embodiment, as in the first embodiment, the smoothing layer 3A (3) is disposed to cover the periphery of the stranded wire 1 with a diameter of about 5 mm or less, which is formed by twisting together element wires 11 with a diameter of about 0.3 mm or less, along the longitudinal direction; however, the form of the stranded wire 1 is not limited thereto as long as the outer circumference of the stranded wire 1 is smoothed by the smoothing layer 3A. Even if the superconducting conductor 10 comprises a smoothing layer 3B or 3C shown in the following Examples in place of the smoothing layer 3A, the form of the stranded wire 1 is not limited as long as the outer circumference of the stranded wire 1 is smoothed by the smoothing layer 3B or 3C.

That is, when the superconducting conductor 10 comprises a smoothing layer 3, the reduction of the critical current in the superconducting tape wire 2 can be reduced or prevented without limitation to the form of the stranded wire 1, as long as the outer circumference of the stranded wire 1 is smoothed by the smoothing layer 3. The effect of reducing or preventing the reduction of the critical current due to the presence of the smoothing layer 3 in the superconducting conductor 10 is exhibited regardless of loss reduction in the superconducting conductor 10.

In addition, as shown in the following Examples, when the bending angle of the superconducting tape wire 2 along the outer circumference of the stranded wire 1 is equal to or less than a predetermined angle, the reduction of the critical current in the superconducting tape wire 2 can be reduced or prevented in the absence of the smoothing layer 3, regardless of the form of the stranded wire 1. According to the Examples, regarding the bending angle of the superconducting tape wire 2 along the outer circumference of the stranded wire 1, the predetermined angle is 12 degrees or less.

### EXAMPLES

Examples of the present invention are shown below to further clarify the characteristics of the present invention. In the Examples and Comparative Examples described below, the core material around which a tape-shaped superconductor wire 2 was to be wound was formed using various stranded wires 1, superconductor wires 2, and smoothing layers 3 (3A, 3B, and 3C), and cable-like superconducting conductors 10 were produced or assumed to be produced. Table 1 shows a list of superconducting conductors that were produced or assumed to be produced. Among these, Comparative Example 1 is a superconducting conductor that was assumed to be produced, and the others are actually produced superconducting conductors. The numbers in parentheses in the wire diameter column of the table are the diameter of wires covered with a heat-shrink tube or wound with Hastelloy tape. PEY in the same column means that the diameter increases slightly due to the winding of a Tetoron thread.

In Example 1, the tape-shaped superconductor wire 2 used was a multifilament superconductor wire 2F (number of filaments: 5) of the form shown in FIG. 7(C). In Examples 2 to 6 and Comparative Examples 1 to 3, the tape-shaped superconductor wire 2 used was a monofilament superconductor wire 2D of the form shown in FIG. 7(A). In Examples 1 to 6, stranded wires (litz wires) obtained by twisting insulated element wires, with the model numbers shown in Table 2, were used.

TABLE 1

| | | Core | Winding | | | Superconducting | |
|---|---|---|---|---|---|---|---|
| | Structure of | material | angle of | Direction of | Number | layer winding | Critical |
| | core | diameter | superconducting | superconducting | of wires/ | direction (number | current |
| | material | (mm) | tape wire (deg) | layer | layers | of layers) | degradation |
| Ex. 1 | Stranded | 2.8 (3.5) | 55 | Inside | 1 | S | (N/A) |
| | wire IZ05 | | | | | | |
| | heat-shrink | | | | | | |
| | tube | | | | | | |
| Ex. 2 | Stranded | 2.8 | 55 | Inside | 1 | S | About half |
| | wire IZ02 | | | | | | |
| Ex. 3 | Stranded | 2.8 (3.0) | 55 | Inside | 1 | Z | About half |
| | wire IZ02 | | | | | | |
| | Hastelloy | | | | | | |
| | tape (S- | | | | | | |
| | twisted, | | | | | | |
| | thickness: | | | | | | |
| | 50 micron) | | | | | | |
| Ex. 4 | Stranded | 2.8 (3.5) | 55 | Inside | 1 | S | None |
| | wire IZ02 | | | | | | |
| | heat-shrink | | | | | | |
| | tube | | | | | | |
| Ex. 5 | Stranded | 2.8 + PEY | 55 | Inside | 1 | S | None |
| | wire IZ05 | | | | | | |
| | with Tetoron | | | | | | |
| | thread | | | | | | |
| Ex. 6 | Stranded | 3.2 | 55 | Inside | 1 | S | None |
| | wire IZ06 | | | | | | |
| | without | | | | | | |
| | Tetoron | | | | | | |
| | thread | | | | | | |
| Comp. | Copper | 3 | 55 | Inside | 1 | S | (N/A) |
| Ex. 1 | (solid) | | | | | | |
| Comp. | GFRP | 3 | 55 | Inside | 1 | S | None |
| Ex. 3 | (solid) | | | | | | |

TABLE 2

| | IZ02 | IZ05 | IZ06 |
|---|---|---|---|
| | 7/6/2UEW | 17/25/USTC | 23/25/USTC |
| | 0.30 mm | 0.10 mm | 0.10 mm |
| Element wire | 0.3 mm | 0.1 mm | 0.1 mm |
| diameter | | | |
| Number of twists | 7 * 6 = 42 | 17 * 25 = 425 | 23 * 25 = 575 |
| Twisting | S(rope)/Z | S/S | S/S |
| direction | | | |
| Twist pitch | 30 mm | 50 mm/50 mm | 50 mm/50 mm |
| Finished | 2.8 mm | 2.8 mm | 3.2 mm |
| diameter | (calculated | (calculated | (calculated |
| | value) | value) | value) |

The loss reduction was verified based on Example 1 and Comparative Examples 1 and 2. The reduction of the critical current was verified based on Examples 2 to 6 and Comparative Example 3.

### Verification Regarding Loss

In Example 1 and Comparative Examples 1 and 2 described below, the loss was measured for each of the produced superconducting conductors and the prepared flat superconductor wires 2. From the loss obtained through measurement, it was observed how the measured loss value changed depending on the configuration of the superconducting conductor.

### Example 1

In Example 1, a resin tube was used to cover the periphery of a stranded wire 1, and further a superconducting tape wire 2 was spirally wound around its surface to produce a superconducting conductor 10. The stranded wire 1 used was model number IZ05. The tape-shaped superconductor wire 2 used was a multifilament superconductor wire 2F of the form shown in FIG. 7(C).

### Comparative Example 1

In Comparative Example 1, the assumed superconducting conductor was such that a solid copper single wire with a diameter of 3 mm was used as a core material, and a superconducting tape wire 2 was spirally wound directly around the core material. The tape-shaped superconductor wire 2 used was a monofilament superconductor wire 2D of the form shown in FIG. 7(A).

### Comparative Example 2

As Comparative Example 2, the same tape-shaped superconductor wire 2 (2D) as that used in Comparative Example 1 was prepared. The superconductor wire 2 was measured for loss in a flat state without spirally winding around the core material. The direction of a magnetic field applied to superconducting tape wire 2 in the loss measurement was perpendicular to the tape surface.

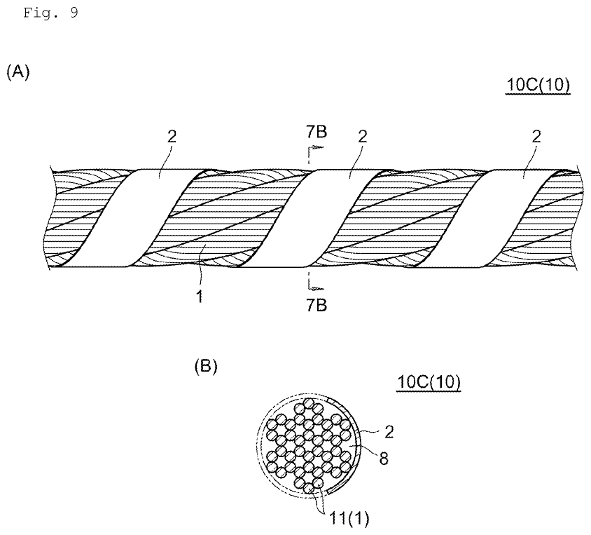

FIG. 8 is a graph showing the verification results of the loss reduction effect. (a) shows loss measured in the superconducting conductor 10 produced in Example 1. (b) shows loss measured in the superconducting conductor assumed as Comparative Example 1. In (b), the lower part of the bar graph shows loss in the core material (core) and the upper part shows loss in the superconducting tape wire (SC). (c) shows loss measured in the tape-shaped superconductor wire 2 (2D) in a flat state prepared as Comparative Example 2.

In Comparative Example 1, loss in the core material (eddy current loss) and loss in the superconducting tape wire (AC loss) were measured separately. That is, as the loss in the core material, the eddy current loss was measured in a solid copper single wire with a diameter of 3 mm, and as the AC loss in the superconducting tape wire, AC loss was measured in the superconducting tape wire 2 spirally wound directly around a GFRP core material with a diameter of 3 mm.

The measured value of loss in Example 1 shown in (a) includes eddy current loss in the stranded wire 1, which is the core material; however, this is extremely small and can be ignored. Therefore, the measured value of loss in Example 1 was determined to be approximately equal to the AC loss in the superconducting tape wire 2.

In the measured values of Comparative Example 1 shown in (b), the reason for the larger loss in the core material in the lower part of the bar graph was determined to be that the core material was solid, rather than the stranded wire 1.

Regarding the loss in the superconducting tape wire 2, the reason for the smaller measured value of Comparative Example 1 shown in the upper part of the bar graph (b) than the measured value of Comparative Example 2 shown in (c) was determined to be due to the effect of spirally winding the superconducting tape wire 2 around the core material, that is, because the part exposed to an AC magnetic field in the transverse direction and in the direction perpendicular to the tape surface within the unit length (1 m) of the superconducting tape wire 2 became shorter.

The reason for the smaller loss in Example 1 shown in (a) than the loss in Comparative Example 1 shown in the upper part of the bar graph (b) was determined to be due to the effect of multifilamentizing the superconducting tape wire 2.

### Verification Regarding Critical Current

In Examples 2 to 6 and Comparative Example 3 described below, the electric field-current characteristics of each of the produced superconducting conductors 10 were measured. The electric field-current characteristics were measured before and after the superconducting tape wire 2 was spirally wound around the core material. From the electric field-current characteristics obtained through measurement, it was confirmed whether the critical current was degraded before and after winding the superconducting tape wire 2. The critical current value was the current value when destruction of the superconducting state was confirmed.

### Example 2

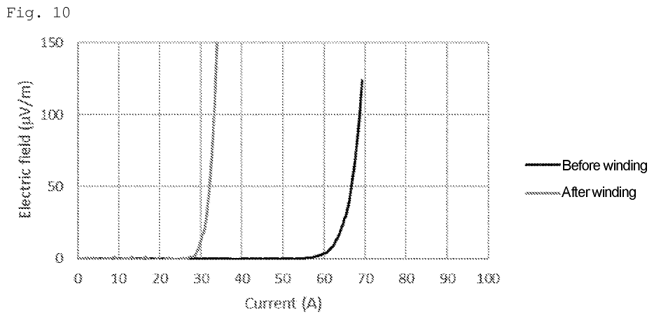

FIG. 9 shows diagrams schematically illustrating the configuration of a superconducting conductor 10C (10) produced in Example 2. FIG. 9(A) is a side view of the superconducting conductor 10C, and FIG. 9(B) is a cross-sectional view of the superconducting conductor 10C taken along line 7B-7B shown in FIG. 9(A).

In Example 2, a superconducting tape wire 2 was spirally wound directly around a stranded wire 1 to produce a superconducting conductor 10C. The stranded wire 1 used was model number IZ02 with an element wire diameter of 0.3 mm and a finished diameter of 2.8 mm. In the model number IZ02, six element wires 11 were Z-twisted to form one primary stranded wire, and seven primary stranded wires were S-twisted to form one stranded wire 1.

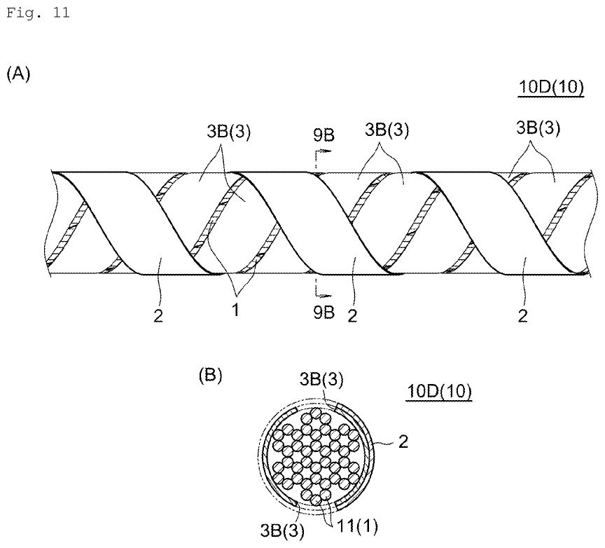

FIG. 10 shows the measurement results of the electric field-current characteristics of the superconducting conductor 10C (10) produced in Example 2. According to the measurement results shown in FIG. 10, in the superconducting conductor 10C of Example 2, destruction of the superconducting state was confirmed in about half of the current value, compared to the superconducting tape wire 2 alone before being spirally wound. A comparison on the critical current confirmed that the performance of the superconducting conductor 10C of Example 2 was about half of that of the superconducting tape wire 2 alone.

According to the detailed observations of the inventors, voids 8 were observed between the stranded wire 1 and the superconducting tape wire 2 in the superconducting conductor 10C, and bending of the superconducting tape wire 2 along the outer circumference of the stranded wire 1 was observed near some of the voids 8. From this, bending of the superconducting tape wire 2 was assumed to be caused by unevenness present in the outer circumference of the stranded wire 1. Compared to a superconducting conductor 90 produced in Comparative Example 3 described later, it was assumed that bending of the superconducting tape wire 2 along the outer circumference of the stranded wire 1 caused the degradation of the critical current.

In the stranded wire of the model number IZ02 used in Example 2, the diameter of the element wires 11 was 0.3 mm, which was relatively thicker than the diameter 0.1 mm of element wires 11 in model number IZ05 or IZ06 used in Examples 5 and 6 described later. Further, in the stranded wire of the model number IZ02, the twisting direction was different when the element wires 11 were twisted to form a primary stranded wire, and when the primary stranded wires were twisted to form the final stranded wire 1.

Subsequently, in Example 2, the bending angle of the superconducting tape wire 2 along the outer circumference of the stranded wire 1 was calculated to confirm, regarding the degree of degradation of the critical current, how much unevenness in the outer circumference of the stranded wire 1 could be allowed.

Approximately 29 element wires with an element wire diameter of 0.3 mm are lined up in a circumference of 8.8 mm calculated from the core material diameter of 2.8 mm. That is, the core material is assumed to be a 29-square, not a perfect circle. Further assuming that it is a regular 29-angle, its exterior angles are about 12 degrees. Considering that the superconducting tape wire is wound and bent along the 29-square core material, the bending angle is assumed to be 12 degrees.

As shown in the measurement results shown in FIG. 10, it was confirmed that the performance in Example 2 was about half of that of the superconducting tape wire 2 alone. In this case, the bending angle of the superconducting tape wire 2 along the outer circumference of the stranded wire 1 was assumed to be 12 degrees. Therefore, according to Example 2, it was confirmed that when the bending angle of the superconducting tape wire 2 was 12 degrees or less, regarding the degree of degradation of the critical current, the performance demonstrated was about half of that of the superconducting tape wire 2 alone.

### Example 3

FIG. 11 shows diagrams schematically illustrating the configuration of a superconducting conductor 10D (10) produced in Example 3. FIG. 11(A) is a side view of the superconducting conductor 10D, and FIG. 11(B) is a cross-sectional view of the superconducting conductor 10D taken along line 9B-9B shown in FIG. 11(A).

In Example 3, as a smoothing layer 3B (3), tape-shaped Hastelloy (registered trademark) was spirally wound around a stranded wire 1, and further a superconducting tape wire 2 was spirally wound around its surface to produce a superconducting conductor 10D. The stranded wire 1 used was model number IZ02, as in Example 2. Two metal Hastelloy tapes were spirally wound in parallel around the stranded wire 1. The winding direction of the superconducting tape wire 2 was Z-winding, and that of the Hastelloy tapes was S-winding.

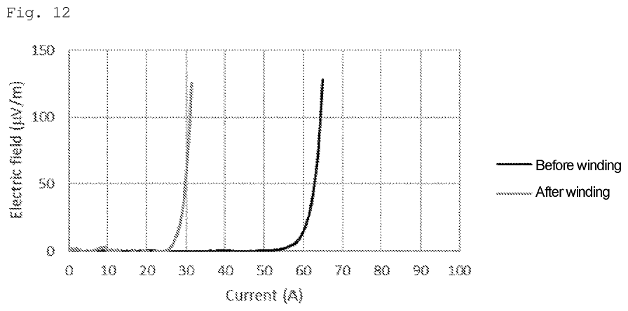

FIG. 12 shows the measurement results of the electric field-current characteristics of the superconducting conductor 10D (10) produced in Example 3. According to the measurement results shown in FIG. 12, in the superconducting conductor 10D of Example 3, destruction of the superconducting state was confirmed in about half of the current value, compared to the superconducting tape wire 2 alone before being spirally wound. A comparison on the critical current confirmed that the performance of the superconducting conductor 10D of Example 3 was about half of that of the superconducting tape wire 2 alone.

### Example 4

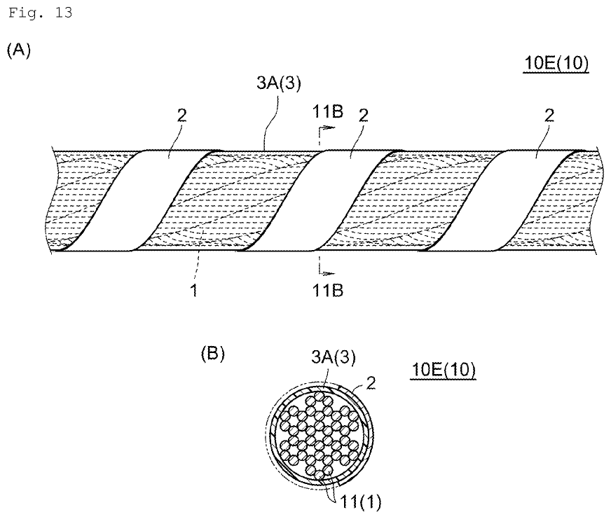

FIG. 13 shows diagrams schematically illustrating the configuration of a superconducting conductor 10E (10) produced in Example 4. FIG. 13(A) is a side view of the superconducting conductor 10E, and FIG. 13(B) is a cross-sectional view of the superconducting conductor 10E taken along line 11B-11B shown in FIG. 13(A).

In Example 4, a resin tube was used as a smoothing layer 3A (3) to cover the periphery of a stranded wire 1, and further a superconducting tape wire 2 was spirally wound around its surface to produce a superconducting conductor 10D. The stranded wire 1 used was model number IZ02, as in Example 2.

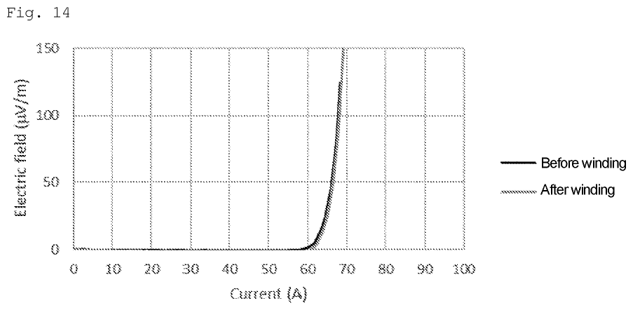

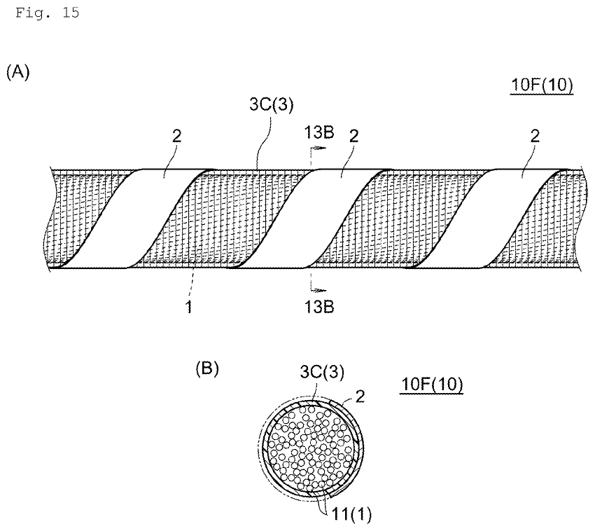

FIG. 14 shows the measurement results of the electric field-current characteristics of the superconducting conductor 10E (10) produced in Example 4. According to the measurement results shown in FIG. 14, in the superconducting conductor 10E of Example 4, destruction of the superconducting state was confirmed in approximately the same current value, compared to the superconducting tape wire 2 alone before being spirally wound. This confirmed that the use of the resin tube as the smoothing layer 3A did not result in substantial degradation of the critical current before and after winding the superconducting tape wire 2.

### Example 5

FIG. 15 shows diagrams schematically illustrating the configuration of a superconducting conductor 10F (10) produced in Example 5. FIG. 15(A) is a side view of the superconducting conductor 10F, and FIG. 15(B) is a cross-sectional view of the superconducting conductor 10F taken along line 13B-13B shown in FIG. 15(A).

In Example 5, a Tetoron (registered trademark) thread (or fiber) was used as a smoothing layer 3C (3) to cover the periphery of a stranded wire 1, and further a superconducting tape wire 2 was spirally wound around its surface to produce a superconducting conductor 10F. Tetoron is made of a polyester resin.

Unlike the model number IZ02 used in Examples 2 to 4, the stranded wire 1 used herein was model number IZ05 with an element wire diameter of 0.1 mm and a finished diameter of 2.8 mm. The diameter 0.1 mm of the element wires 11 in the model number IZ05 was thinner than the diameter 0.3 mm of the element wires 11 in the model number IZ02 used in Examples 2 to 4. In the model number IZ05, the twisting direction was the same S-twist when twisting the element wires 11 to form a primary stranded wire and when twisting the primary stranded wires to form the final stranded wire 1. The twist pitch was also the same 50 mm when twisting the element wires 11 to form a primary stranded wire and when twisting the primary stranded wires to form the final stranded wire 1.

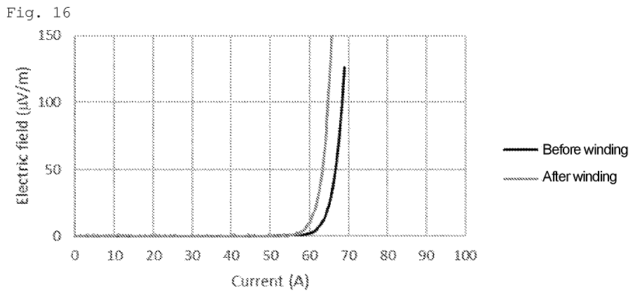

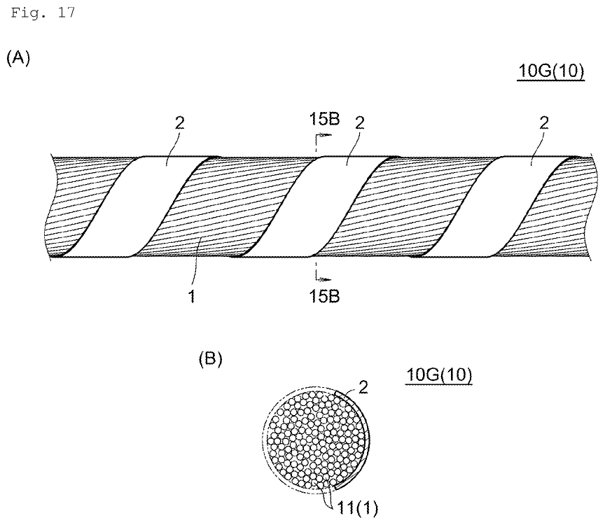

FIG. 16 shows the measurement results of the electric field-current characteristics of the superconducting conductor 10F (10) produced in Example 5. According to the measurement results shown in FIG. 16, in the superconducting conductor 10F of Example 5, destruction of the superconducting state was confirmed in approximately the same current value, compared to the superconducting tape wire 2 alone before being spirally wound. This confirmed that the use of the Tetoron thread as the smoothing layer 3C did not result in substantial degradation of the critical current before and after winding the superconducting tape wire 2, regardless of the type of stranded wire 1.

### Example 6

FIG. 17 shows diagrams schematically illustrating the configuration of a superconducting conductor 10G (10) produced in Example 6. FIG. 17(A) is a side view of the superconducting conductor 10G, and FIG. 17(B) is a cross-sectional view of the superconducting conductor 10G taken along line 15B-15B shown in FIG. 17(A).

In Example 6, the smoothing layer 3C was omitted from the superconducting conductor 10F produced in Example 5 to produce a superconducting conductor 10G. In Example 6, a superconducting tape wire 2 was spirally wound directly around a stranded wire 1 to produce the superconducting conductor 10G. Unlike the superconducting conductor 10F produced in Example 5, the stranded wire 1 in the superconducting conductor 10G was not covered with a Tetoron thread.

In Example 6, the stranded wire 1 used was model number IZ06 with an element wire diameter of 0.1 mm and a finished diameter of 3.2 mm. The diameter 0.1 mm of the element wires 11 in the model number IZ06 is equal to the diameter 0.1 mm of the element wires 11 in the model number IZ05 used in Example 5. As in the model number IZ05, in the model number IZ06, the twisting direction was the same S-twist when twisting the element wires 11 to form a primary stranded wire and when twisting the primary stranded wires to form the final stranded wire 1. The twist pitch was also the same 50 mm when twisting the element wires 11 to form a primary stranded wire and when twisting the primary stranded wires to form the final stranded wire 1.

About 100 element wires with an element wire diameter of 0.1 mm are lined up on a circumference of 10 mm calculated from the diameter of 3.2 mm of the core material. That is, the core material is assumed to be a 100-square, not a perfect circle. Further assuming that it is a regular 100-square, its exterior angles are about 3.6 degrees. Considering that the superconducting tape wire is wound and bent along the regular 100-square core material, the bending angle is assumed to be 3.6 degrees even if bending occurs.

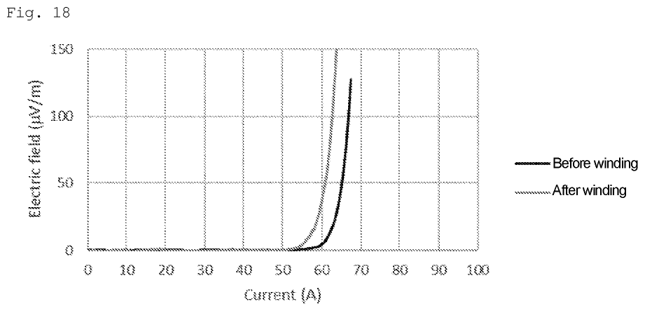

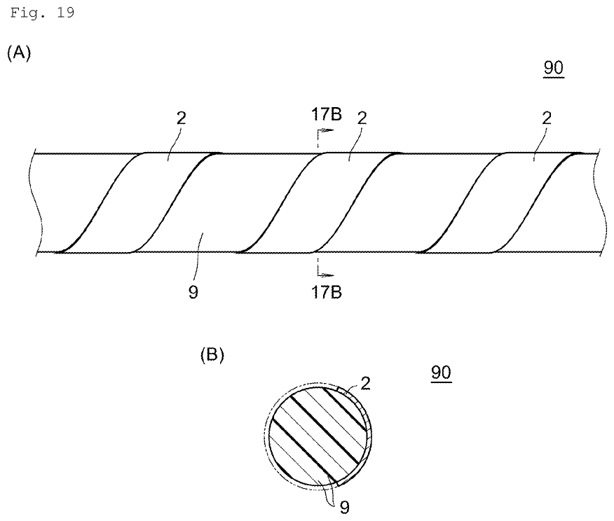

FIG. 18 shows the measurement results of the electric field-current characteristics of the superconducting conductor 10G (10) produced in Example 6. According to the measurement results shown in FIG. 18, in the superconducting conductor 10G of Example 6, destruction of the superconducting state was confirmed in approximately the same current value, compared to the superconducting tape wire 2 alone before being spirally wound. This confirmed that if the diameter of the element wires 11 was thinner than about 0.1 mm, and if the twisting direction and twist pitch were the same when twisting the element wires 11 to form a primary stranded wire and when twisting the primary stranded wires to form the final stranded wire 1, there was no substantial degradation of the critical current before and after winding the superconducting tape wire 2 even if the smoothing layer 3 was not provided.

Subsequently, in Example 6, the bending angle of the superconducting tape wire 2 along the outer circumference of the stranded wire 1 was calculated to confirm, regarding the degree of degradation of the critical current, how much unevenness in the outer circumference of the stranded wire 1 could be allowed.

As shown in the measurement results shown in FIG. 18, it was confirmed that in Example 6, there was no substantial degradation of the critical current before and after winding the superconducting tape wire 2 even if the smoothing layer 3 was not provided. In this case, the bending angle of the superconducting tape wire 2 along the outer circumference of the stranded wire 1 was assumed to be 3.6 degrees. Therefore, according to Example 6, it was confirmed that when the bending angle of the superconducting tape wire 2 was 3.6 degrees or less, there was no substantial degradation of the critical current even if the smoothing layer 3 was not provided.

### Comparative Example 3

FIG. 19 shows diagrams schematically illustrating the configuration of a superconducting conductor 90 produced as Comparative Example 3. FIG. 19(A) is a side view of the superconducting conductor 90, and FIG. 19(B) is a cross-sectional view of the superconducting conductor 90 taken along line 17B-17B shown in FIG. 19(A).

In Comparative Example 3, a glass fiber-reinforced resin with a flat surface (glass fiber-reinforced plastics; GFRP) was used as a core material 9, and a superconducting tape wire 2 was spirally wound directly around the GFRP core material 9 to produce a superconducting conductor 90. Since the core material 9 was not flexible, the superconducting conductor 90 was not flexible either.

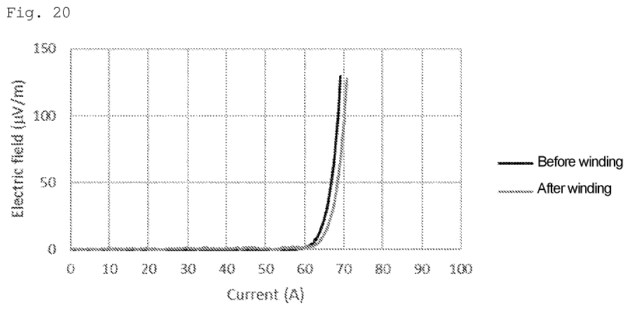

FIG. 20 shows the measurement results of the electric field-current characteristics of the superconducting conductor 90 produced in Comparative Example 3. According to the measurement results shown in FIG. 20, in the superconducting conductor 90 of Comparative Example 3, destruction of the superconducting state was confirmed in approximately the same current value, compared to the superconducting tape wire 2 alone before being spirally wound. This confirmed that when spirally winding the superconducting tape wire 2 along the surface of the core material 9 along the longitudinal direction, if the surface of the core material 9 was flat, there was no degradation of the critical current before and after winding the superconducting tape wire 2.

### DESCRIPTION OF REFERENCE SYMBOLS

1: Stranded wire
2 (2A, 2B, 2C, 2D, 2E, 2F): Tape-shaped superconductor wire (superconducting tape wire)
3 (3A, 3B, 3C): Smoothing layer
8: Void
9: Core material
10 (10A, 10B, 10C, 10D, 10E, 10F, 10G): Cable-like superconducting conductor
11: Element wire
21: Substrate
22 (22a): Superconductor layer
23: Insulating section
24: Connecting section
(25a, 25b): Conducting layer
27: Copper shunt layer
90: Cable-like superconducting conductor produced as Comparative Example
98: Persistent eddy current
99: Coupling current

1. A superconducting conductor comprising:
a stranded wire having a plurality of metal element wires twisted together; and
one or more tape-shaped superconductor wires each having a superconductor layer formed on a surface of a flexible substrate, and being spirally wound around the stranded wire along its longitudinal direction,
the metal element wires having a diameter of 0.3 mm or less, and the stranded wire having a diameter of 5 mm or less.

2. The superconducting conductor according to claim 1, wherein an angle made between the longitudinal direction of each superconductor wire and the longitudinal direction of the stranded wire is 45 degrees or more and less than 90 degrees.

3. The superconducting conductor according to claim 1, wherein the metal element wires are twisted in the same direction.

4. The superconducting conductor according to claim 1, wherein the metal element wires are twisted with the same twist pitch.

5. The superconducting conductor according to claim 1, further comprising a flexible smoothing layer disposed between the stranded wire and the superconductor wires so as to cover the periphery of the stranded wire along its longitudinal direction.

6. The superconducting conductor according to claim 5, wherein the smoothing layer is made of a resin or a metal, and covers the periphery of the stranded wire cylindrically or spirally.

7. The superconducting conductor according to claim 1, comprising a plurality of the superconductor wires, wherein the superconductor wires are spirally wound around the stranded wire along its longitudinal direction.

8. The superconducting conductor according to claim 7, wherein the superconductor wires are spirally wound around the stranded wire along its longitudinal direction in different directions.

9. The superconducting conductor according to claim 1, wherein in the superconductor wires, a plurality of the superconductor layers extend in the longitudinal direction of the substrate and are arranged in parallel to the transverse direction of the substrate.

10. The superconducting conductor according to claim 1, further comprising one or more normally conductive materials each electrically connecting one or more of the superconductor wires and at least one of the metal element wires of the stranded wire.

11. The superconducting conductor according to claim 1, further comprising a plurality of normally conductive materials each electrically connecting one or more of the superconductor wires and at least one of the metal element wires of the stranded wire,
wherein the normally conductive materials are arranged to minimize the integral value of a magnetic field in a transverse direction with respect to the superconducting conductor in a section of the superconducting conductor between adjacent normally conductive materials.

12. A superconducting conductor comprising:
a stranded wire having a plurality of metal element wires twisted together;
one or more tape-shaped superconductor wires each having a superconductor layer formed on a surface of a flexible substrate, and being spirally wound around the stranded wire along its longitudinal direction; and
a flexible smoothing layer disposed between the stranded wire and the superconductor wires so as to cover the periphery of the stranded wire along its longitudinal direction.

13. A superconducting conductor comprising:
a stranded wire having a plurality of metal element wires twisted together; and
one or more tape-shaped superconductor wires each having a superconductor layer formed on a surface of a flexible substrate, and being spirally wound around the stranded wire along its longitudinal direction,
the superconductor wires having a bending angle of 12 degrees or less along the outer circumference of the stranded wire.

14. A winding wound with the superconducting conductor according to claim 1.

15. A winding wound with the superconducting conductor according to claim 12.

16. A winding wound with the superconducting conductor according to claim 13.
